(19) United States
(12) Patent Application Publication
(10) Pub. No.: US 2017/0118322 A1
(43) Pub. Date: Apr. 27, 2017

(54) REMOTE CONTROL METHOD AND DEVICE

(71) Applicant: Leauto Intelligent Technology (BEIJING) Co., Ltd., Beijing (CN)

(72) Inventors: Binglin Feng, Beijing (CN); Yi Chen, Beijing (CN)

(21) Appl. No.: 14/960,321

(22) Filed: Dec. 4, 2015

(30) Foreign Application Priority Data
Oct. 21, 2015 (CN) 201510694706.7

(51) Int. Cl. H04M 1/725; H04W 12/08; H04W 4/12

(52) U.S. Cl. CPC H04M 1/72533; H04W 4/12; H04W 12/08

(57) ABSTRACT

The present disclosure discloses a remote control method and device, the method including: establishing Beidou short message connection with a second apparatus; authorizing control permission to the second apparatus via the Beidou short message connection; and receiving and executing a control command in accordance with the control permission from the second apparatus via the Beidou short message connection. The present disclosure may avoid the problem that the remote unlocking cannot be responded in time due to instable signal connection. Thusly, the faulted vehicle can be controlled remotely fast and in time, the efficiency of remote control may be increased, and the data traffic cost may be reduced.

### CROSS-REFERENCE TO RELATED APPLICATIONS

This application is based upon and claims priority to Chinese Patent Application No. CN201510694706.7 filed Oct. 21, 2015, the entire contents of all of which are incorporated herein by reference.

### TECHNICAL FIELD

The embodiments of the present disclosure relate to the field of wireless communication, and in particular to a remote control method and device.

### BACKGROUND

With the development of economic and technology, vehicle becomes necessities of people's daily life. However, during usage of vehicle, a user usually meets problems as below: the door is locked during driving, due to vehicle failure or accident, and the user cannot open the door from interior of the vehicle. At that moment, he or she needs to be rescued, and the vehicle needs to be unlocked by others from remote.

Conventionally, a process of remote controlling a faulted vehicle is: the owner of the faulted vehicle may authorize the control permission of the faulted vehicle to specified user temporarily via wireless network, to allow the specified user to have temporary authority of the faulted vehicle and control the faulted vehicle remotely to unlock the door. In the temporary authority solution, wireless network may include mobile communication network, such as 2G (2nd-Generation wireless telephone technology), 3G (3rd-Generation mobile communication technology), 4G (4th-Generation mobile communication technology), Wimax (Worldwide Interoperability for Microwave Access) network, RFID (radio frequency identification), Bluetooth network and so on.

However, the wireless network may be instable. For example, when using 2G/3G/4G mobile communication networks to perform temporary authority to the faulted vehicle, if the vehicle parks where there has weak signal connection, the temporary authority is hard to succeed, thusly remote controlling the vehicle is inefficiency. In addition, users have to pay for the data traffic cost when using 2G/3G/4G network, which results in a high cost.

### SUMMARY

The present disclosure discloses a remote control method and device, to solve the problem in the prior art that the remote control has low efficiency and high cost, increases the efficiency of remote control and reduces the data traffic cost.

The present disclosure provides a remote control method, adapted to a first apparatus, including:

establishing Beidou short message connection with a second apparatus;

authorizing control permission to the second apparatus via the Beidou short message connection; and

receiving and executing a control command in accordance with the control permission from the second apparatus via the Beidou short message connection.

According to another aspect of the present disclosure, a remote control method is provided, the remote control method is adapted to a second apparatus, including:

establishing a Beidou short message connection with a first apparatus;

receiving a control permission authorized by the first apparatus via the Beidou short message connection;

sending a control command in accordance with the control permission to the first apparatus via the Beidou short message connection.

According to still another aspect of the present disclosure, a remote control device adapted to a first apparatus is provided, including:

a first connection establishing module, configured to establish a Beidou short message connection with a second apparatus;

an authorization module, configured to authorizing a control permission to the second apparatus via the Beidou short message connection; and

an instruction receiving executing module, configured to receive and execute a control command in accordance with the control permission from the second apparatus via the Beidou short message connection.

According to further still another aspect of the present disclosure, a remote control device, adapted to a second apparatus is provided, including:

a second connection establishing module, configured to establish Beidou short message connection with a first apparatus;

an authorization receiving module, configured to receiving a control permission authorized by the first apparatus via the Beidou short message connection; and

a control command sending module, configured to send a control command in accordance with the control permission to the first apparatus via the Beidou short message connection.

According to another aspect of the present disclosure, a remote control device adapted to a first apparatus is provided, the device includes:

at least a first processor;

a first memory for storing at least one instruction executable by the first processor;

wherein the first processor is configured to:

establish a Beidou short message connection with a second apparatus;

authorize a control permission to the second apparatus via the Beidou short message connection; and

receive and execute a control command in accordance with the control permission from the second apparatus via the Beidou short message connection.

According to still another aspect of the present disclosure, a remote control device adapted to a second apparatus is provided, the device includes:

at least a second processor;

a second memory for storing at least one instruction executable by the second processor;

wherein the second processor is configured to:

establish Beidou short message connection with a first apparatus;

receive a control permission authorized by the first apparatus via the Beidou short message connection; and

send a control command in accordance with the control permission to the first apparatus via the Beidou short message connection.

According to the remote control method and device, after Beidou short message connection is established between the first apparatus and the second apparatus, the first apparatus may authorize control permission to the second apparatus via Beidou short message connection, and receive and execute the control command in accordance with the control permission from the second apparatus, such as opening the door. Therefore the vehicle owner can be rescued. As communication with Beidou short message connection has characteristics such as having stable service, no delay, not relying on mobile communication network, as a result, compared with prior art, the present disclosure may avoid the problem that the door cannot be opened in time during remote unlocking process due to instable signal connection. Thusly, the faulted vehicle can be controlled remotely fast and in time, the efficiency of remote control may be increased, and the data traffic cost may be reduced.

### BRIEF DESCRIPTION OF THE DRAWINGS

In order to more apparently describe the technical schemes in the embodiments of the present disclosure or in the prior art, accompanying figures necessarily used in the description of the embodiments or the prior art will be simply explained hereinafter. Obviously, the accompanying figures described below will form the embodiments of the present disclosure. An ordinary person skilled in the art may conceive further figures in accordance with these accompanying figures without contributing creative labor.

FIG. 1 is a flow chart showing the steps of the remote control method in an embodiment of the present disclosure.

FIG. 2 is a flow chart showing the steps of establishing Beidou short message connection with a second apparatus according to the present disclosure;

FIG. 3 is a flow chart showing the steps of the remote control method in a second embodiment of the present disclosure;

FIG. 4 is a flow chart showing the steps of the remote control method in a third embodiment of the present disclosure;

FIG. 5 is a block diagram showing the structure of the remote control device in a first embodiment of the present disclosure;

FIG. 6 is a block diagram showing the structure of the remote control device in a second embodiment of the present disclosure.

FIG. 7 is a block diagram schematically showing remote control device according to the present disclosure.

FIG. 8 is a schematic diagram showing a memory for saving or carrying instructions according to the present disclosure.

### DETAILED DESCRIPTION

In order that objectives, technical schemes and advantages of the embodiments of the present disclosure become more apparent, the technical schemes in the embodiments of the present disclosure will be thoroughly and completely described below in conjunction with the accompanying figures in the embodiments of the present disclosure. It is obvious that the embodiments described herein are some of embodiments of the present disclosure rather than entire embodiments. On the basis of the embodiments of the present disclosure, other embodiments conceived by an ordinary person skilled in the art without creative labor would all fall into the scope of the present disclosure.

### The First Embodiment

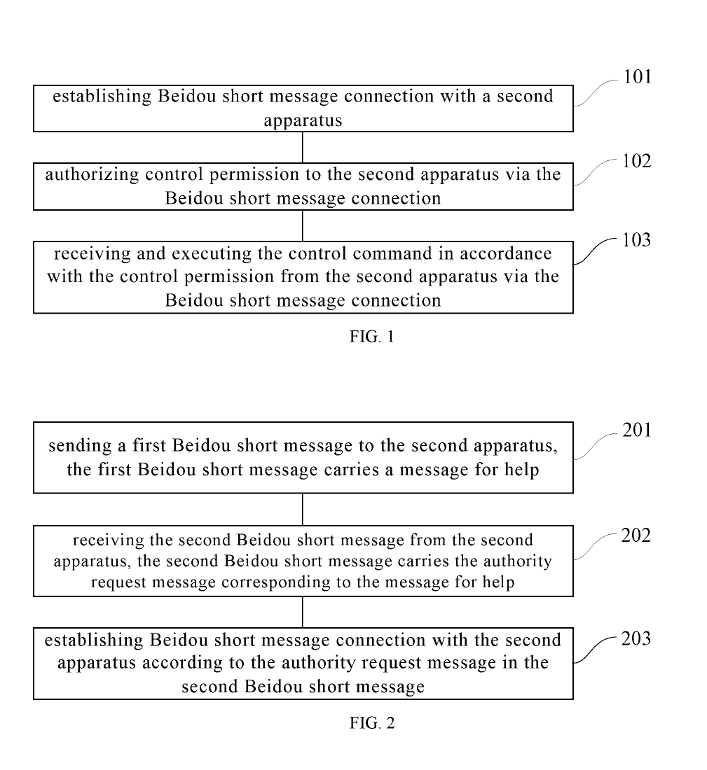

Referring to FIG. 1, it is a flow chart showing the steps of the remote control method in an embodiment of the present disclosure. The embodiment may be adapted to a first apparatus, and may include the following steps:

Step 101, establishing Beidou short message connection with a second apparatus;

The embodiment of the present disclosure may be adapted to apparatus in which Beidou terminal has been mounted therein and the Beidou terminal has been provided Beidou short message function. The Beidou terminal may be, for example, the terminal apparatus using Beidou second generation satellite navigation system to perform positioning and navigation. The embodiment of the present disclosure does not limit the type of the Beidou terminal. in a practical example of the present disclosure, when the first apparatus cannot send operation instructions by itself, it may establish Beidou short message connection between its Beidou terminal and the Beidou terminal of the second apparatus, and authorize control permission to the second apparatus to allow the second apparatus to control the first apparatus remotely and send operation instruction to the first apparatus, thereby making the first apparatus execute corresponding operation instruction.

It should be noted that, the first apparatus and the second apparatus in the embodiment of the present disclosure are apparatus provided with Beidou terminals, the different expression is just for better illustration the process points they are respectively located. They may actually be the same apparatus. For example, the present disclosure may be adapted to “two buses and a dangerous” vehicles, the “two buses and a dangerous” vehicles may refer to shuttle buses for working in three types, touring buses for travel, and dangerous cargo carrier special vehicles for carrying dangerous chemistry products, fireworks and firecracker, civil explosives. According to regulations such as “National important operating vehicle inspection measures of network spreading system” and “Road transport vehicle satellite positioning system standards conformance technical review” from Ministry of Communications of China, “two buses and a dangerous” vehicles should be equipped with up-to-standard Beidou navigation satellite systems.

Because of mandatory requirement of Ministry of Communications, “two buses and a dangerous” vehicles must be equipped with Beidou terminal, thusly the embodiment of the present disclosure may be directly applied to “two buses and a dangerous” vehicles. It should be understood that, the embodiment of the present disclosure may also be applied to any vehicles equipped with the Beidou terminal. The detailed type of the first apparatus and the second apparatus is not limited.

Step 102, authorizing control permission to the second apparatus via the Beidou short message connection;

After the Beidou short message connection is established between the first apparatus and the second apparatus, a Beidou short message may be transmitted between the first apparatus and the second apparatus via Beidou terminal. The Beidou short message is a special function of the Beidou satellite navigation system, the function is two-way message transmission between each two of a satellite positioning terminal, a Beidou satellite and a Beidou ground station via satellite signals, and is independent from communication network. In addition, the Beidou short message has the characteristic of being stable and having no delay, compared with the prior art, it may avoid the problem that the remote unlocking cannot be responded in time due to instable network signal, and can control the faulted vehicle remotely fast and in time, increases the efficiency of remote controlling vehicle, reduces network data traffic cost.

In detail application, the first apparatus may authorize control permission to the second apparatus via the Beidou short message connection using the Beidou short message. For example, the control permission may be the permission of unlocking the door, starting the vehicle and so on, the detail content of the control permission is not limited in the embodiment of the present disclosure. In a preferred embodiment of the present disclosure, it is also capable to set a validity period for the control permission, such as setting the control permission as temporary authorization, which can only be used once. This prevents the second apparatus from remotely controlling the first apparatus after the rescue is finished, which may cause the normal usage of the first apparatus or generate potential safety hazard to the first apparatus.

Step 103, receiving and executing the control command in accordance with the control permission from the second apparatus via the Beidou short message connection.

In a preferred embodiment of the present disclosure, the control permission may include an unlock permission, the control command in accordance with the control permission may include an unlock instruction;

the step of receiving and executing the control command in accordance with the control permission from the second apparatus may include sub-steps of:

Sub-step S11, receiving unlock instruction from the second apparatus;

in detail application, the second apparatus may send unlock instruction to the first apparatus via the Beidou short message.

Sub-step S12, sending the unlock instruction to the instruction control unit via a controller area network;

after the Beidou terminal of the first apparatus receives the unlock instruction, it may send the unlock instruction to a vehicle-mounted controller, the vehicle-mounted controller is used to communicate with the Beidou terminal, the vehicle-mounted controller sends the unlock instruction to the instruction control unit via a CAN (Controller area network) to execute the unlock instruction and unlock the door. Wherein the instruction control unit is configured to manage and control the operation instruction of the apparatus, it may be an ECU (electronic control unit) of the vehicle. The ECU is also called “vehicle driving computer” or “vehicle-mounted computer”, it is a micro controller specific for vehicles. The CAN is a bus communication network efficiently supporting distributed control or real-time control, it belong to internal communication protocol of the vehicle, every vehicle manufacturer has different internal communication protocol from each other, and proper communication protocol may be chosen according to the requirement.

Sub-step S13, executing the unlock instruction via the instruction control unit.

In a practical example of the present disclosure, “two buses and a dangerous” vehicles travel in groups, a certain vehicle has fault and the door is locked. When the owner cannot open the door from interior, he or she may send message for help to a nearby vehicle via Beidou terminal. After the nearby vehicle receives the message for help, it sends an authority request message to the faulted vehicle, the faulted vehicle establishes a Beidou short message connection with the rescue vehicle, by the Beidou short message connection, the faulted vehicle may authorize a one-time open-the-door authority to the rescue vehicle, the rescue vehicle sends open door instruction to the vehicle-mounted controller of the faulted vehicle via a Beidou terminal, the vehicle-mounted controller of the faulted vehicle sends the open door instruction to the ECU of the faulted vehicle through the CAN, to realize door unlocking, thusly performing next rescue procedure to the faulted vehicle.

In the embodiment of the present disclosure, after the first apparatus establish the Beidou short message connection with the second apparatus, it may authorize control permission to the second apparatus via the Beidou short message connection, and receive and execute control command in accordance with the control permission from the second apparatus, such as opening the door to rescue the trapped owner of the vehicle. As communication with Beidou short message connection has characteristics such as having stable service and no delay, and not relying on mobile communication network, as a result, compared with prior art, the present disclosure may avoid the problem that the remote unlocking cannot be responded in time due to instable signal connection. Thusly, the faulted vehicle can be controlled remotely fast and in time, the efficiency of controlling the vehicle remotely may be increased, and the data traffic cost may be reduced.

In addition, “two buses and a dangerous” vehicles are usually travel in group, there may be many vehicle companions nearby. Once a vehicle has accident, it may establish connection with Beidou terminals of nearby vehicles, authorize special door-unlocking permission (one-time permission) to unlock the door and call for rescue, which greatly reduces rescue time, increases rescue efficiency, guarantees the owner of vehicle's life and property safety.

### The Second Embodiment

Based on the first embodiment, the present disclosure provides alternative technical solutions as below.

As shown in FIG. 2, it is a flow chart showing the steps of establishing Beidou short message connection with a second apparatus according to the present disclosure; which may include:

Step 201, sending a first Beidou short message to the second apparatus, the first Beidou short message carries a message for help;

in detail application, a vehicle may be equipped with a call-for-help button, when the vehicle has fault, the user can just press the call-for-help button to send the first Beidou short message via the equipped Beidou terminal, a message for help is carried therein to ensure the in-time rescue. The message for help may be binary code text, the message for help may include message for help identification information, coordinate information of the first apparatus, and call-for-help content. The call-for-help content may be unlocking the door, starting the vehicle and so on. Obviously, in practical application, a skilled person in the art may set the format and content of the message for help flexibly according to requirement, the embodiment of the present disclosure does not limit the format and content of the message for help.

In a preferred embodiment of the present disclosure, the step of sending the first Beidou short message to the second apparatus includes sub-steps of:

Sub-step S21, sending the first Beidou short message to the Beidou satellite; wherein the first Beidou short message carries a message for help;

Sub-step S22, the Beidou satellite forwards the first Beidou short message to a ground control station;

Sub-step S23, the ground control station sends the first Beidou short message to nearby vehicles of the first apparatus;

Sub-step S24, the second apparatus receives the first Beidou short message;

the vehicle nearby the first apparatus will receive the first Beidou short message including the coordinate information of the first apparatus and call-for-help content. If a certain vehicle nearby is convenient to help rescue, it may respond and send a second Beidou short message which includes authority request message corresponding to the call-for-help content, the vehicle is the second apparatus. In a practical example of the present disclosure, the call-for-help content may be unlocking the door, correspondingly, the authority request message may be corresponding unlocking-the-door authority request message.

Step 202, receiving the second Beidou short message from the second apparatus, the second Beidou short message carries the authority request message corresponding to the message for help;

Step 203, establishing Beidou short message connection with the second apparatus according to the authority request message in the second Beidou short message.

After receiving the second Beidou short message from the second apparatus, the first apparatus may establish Beidou short message connection with the second apparatus.

In a preferred embodiment of the present disclosure, it is also capable to verify the authority request message to improve the safety of remote control. The step of establishing Beidou short message connection with the second apparatus according to the authority request message in the second Beidou short message may include sub-steps of:

Sub-step S31, verifying the authority request message and the message for help;

in detailed application, it is capable to examine the authority request message to determine whether the corresponding control permission is authorized to the rescue vehicle temporarily via a vehicle control platform. For example, it is capable to verify the authority request message and the message for help. If the call-for-help content in the message for help is unlocking the door, and the authority request message is unlocking-the-door authority request message, the verification is passed, establishment of Beidou short message connection between the first apparatus and the second apparatus is agreed, or, the verification is failed, establishment of Beidou short message connection between the first apparatus and the second apparatus is rejected.

Sub-step S32, when the authority request message is in accordance with the message for help, establishing the Beidou short message connection between the first apparatus and the second apparatus.

In an embodiment of the present disclosure, when the first apparatus has fault, it may call for help by sending a first Beidou short message. The first Beidou short message may carry a message for help, after the second apparatus receives the message for help and responds to it, the first apparatus may receive a second Beidou short message from the second apparatus, the second Beidou short message may carry an authority request message, the first apparatus may establish the Beidou short message connection with the second apparatus according to the authority request message. According to the Beidou short message connection, the first apparatus may authorize the control permission corresponding to the message for help to the second apparatus, thusly the second apparatus may control and operate the first apparatus to perform rescue.

### The Third Embodiment

The remote control method of the embodiment may be described from the angle of the second apparatus.

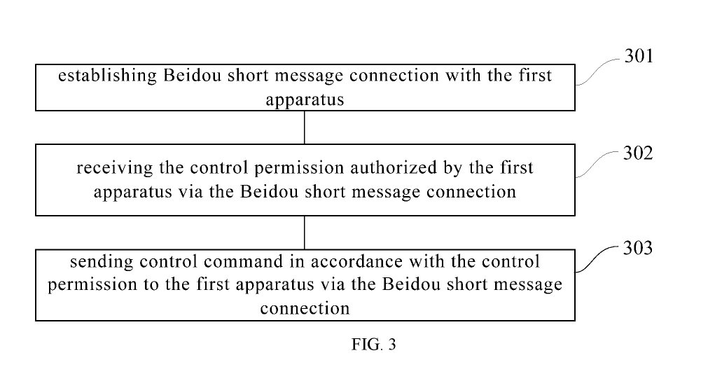

As shown in FIG. 3, it is a flow chart showing the steps of the remote control method in a second embodiment of the present disclosure; the present disclosure may be adapted to the second apparatus, and may include the steps as follows:

Step 301, establishing Beidou short message connection with the first apparatus;

Step 302, receiving the control permission authorized by the first apparatus via the Beidou short message connection;

Step 303, sending control command in accordance with the control permission to the first apparatus via the Beidou short message connection.

In a preferred embodiment of the present disclosure, the step of establishing the Beidou short message connection with the first apparatus may include the sub-steps of:

Sub-step S41, receiving a first Beidou short message from the first apparatus, wherein the first Beidou short message carries the message for help;

Sub-step S42, sending a second Beidou short message to the first apparatus, wherein the second Beidou short message carries the authority request message corresponding to the message for help;

Sub-step S43, establishing Beidou short message connection with the first apparatus according to the responding message from the first apparatus specific to the authority request message.

In the embodiment of the present disclosure, after establishing Beidou short message connection with the first apparatus, the control permission authorized by the first apparatus may be received via the Beidou short message connection, and the control command in accordance with the control permission is sent to the first apparatus, the control command may be opening the door to rescue the first apparatus. As communication with Beidou short message connection has characteristics such as having stable service and no delay, and not relying on mobile communication network, as a result, compared with prior art, the present disclosure may avoid the problem that the remote unlocking cannot be responded in time due to instable signal connection. Thusly, the faulted vehicle can be controlled remotely fast and in time, the efficiency of remote control may be increased, and the data traffic cost may be reduced.

### The Fourth Embodiment

To better illustrate the remote control method of the present disclosure, in the embodiment, detail application examples are used to illustrate the realization process of the present disclosure.

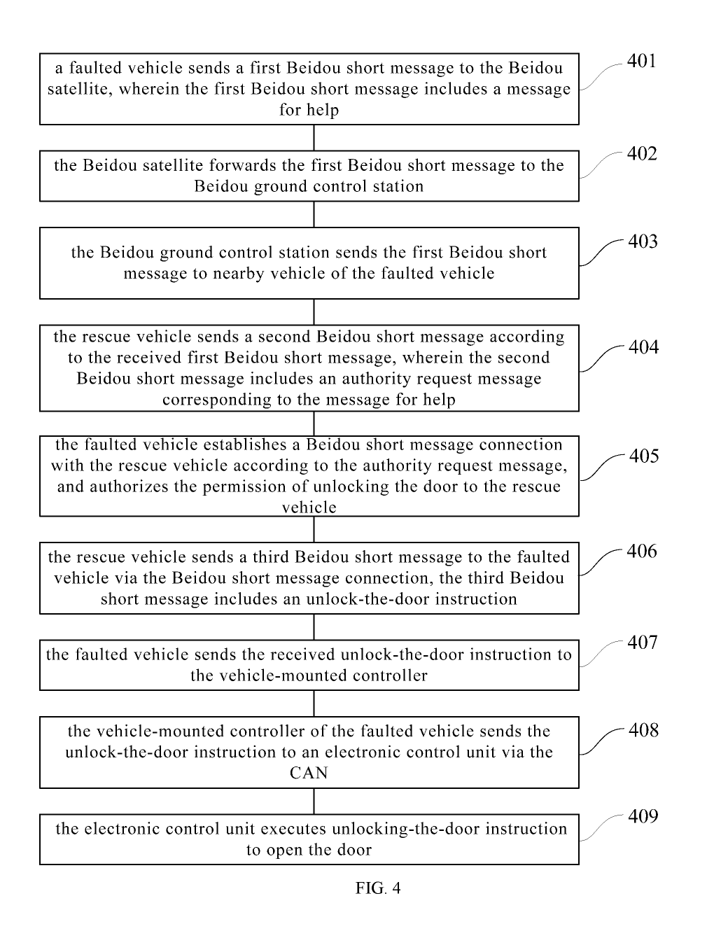

Referring to FIG. 4, it is a flow chart showing the steps of the remote control method in a third embodiment of the present disclosure; which may include:

Step 401, a faulted vehicle sends a first Beidou short message to the Beidou satellite, wherein the first Beidou short message includes a message for help;

In the embodiment of the present disclosure, the message for help includes coordinate information of the faulted vehicle and call-for-help content, the call-for-help content is unlocking the door.

Step 402, the Beidou satellite forwards the first Beidou short message to the Beidou ground control station;

Step 403, the Beidou ground control station sends the first Beidou short message to nearby vehicle of the faulted vehicle;

In the embodiment of the present disclosure, after the vehicle nearby the faulted vehicle receives the first Beidou short message, it agrees to rescue the faulted vehicle, and the vehicle is called rescue vehicle.

Step 404, the rescue vehicle sends a second Beidou short message according to the received first Beidou short message, wherein the second Beidou short message includes an authority request message corresponding to the message for help;

In an embodiment of the present disclosure, the authority request message may be unlocking-the-door authority request message.

Step 405, the faulted vehicle establishes a Beidou short message connection with the rescue vehicle according to the authority request message, and authorizes the permission of unlocking the door to the rescue vehicle.

Step 406, the rescue vehicle sends a third Beidou short message to the faulted vehicle via the Beidou short message connection, the third Beidou short message includes an unlock-the-door instruction.

Step 407, the faulted vehicle sends the received unlock-the-door instruction to the vehicle-mounted controller;

Step 408, the vehicle-mounted controller of the faulted vehicle sends the unlock-the-door instruction to an electronic control unit via the CAN.

Step 409, the electronic control unit executes unlocking-the-door instruction to open the door.

In the embodiment of the present disclosure, the faulted vehicle sends Beidou short message and thusly can call for help from nearby vehicles, the rescue vehicle may remotely control the faulted vehicle in time, unlock the door, solve the problem that the owner of the faulted vehicle is trapped in the vehicle in the shortest time, and ensures the life and property safety of the vehicle owner in the greatest extent, and is also capable of communicating with others.

### First Embodiment of Device

Referring to FIG. 5, it is a block diagram showing the structure according to the remote control device in the first embodiment of the present disclosure, the embodiment may be adapted to a first apparatus, which may include:

the first connection establishing module 510, configured to establish Beidou short message connection with the second apparatus;

an authorization module 520, configured to authorize control permission to the second apparatus via the Beidou short message connection; and

an instruction receiving executing module 530, configured to receive and execute the control command in accordance with the control permission from the second apparatus via the Beidou short message connection.

In a preferred embodiment of the present disclosure, the first connection establishing module 510 includes:

a first sending sub-module, configured to send first Beidou short message to the second apparatus, the first Beidou short message carries a message for help;

a first receiving sub-module, configured to receive second Beidou short message from the second apparatus; the second Beidou short message carries an authority request message corresponding to the message for help;

a first connection establishing sub-module, configured to establish Beidou short message connection with the second apparatus according to the authority request message in the second Beidou short message.

In another preferred embodiment of the present disclosure, the first connection establishing sub-module may further include:

a verifying unit configured to verify the authority request message and the message for help;

a connection establishing unit, configured to establish Beidou short message connection with the second apparatus when the authority request message is in accordance with the message for help.

In still another preferred embodiment of the present disclosure, the control permission may include a unlock permission, the control command in accordance with the control permission may include the unlock instruction;

The instruction receiving executing module may include:

an instruction receiving sub-module, configured to receive the unlock instruction from the second apparatus;

an instruction sending sub-module, configured to send the unlock instruction to the instruction control unit via the controller area network;

an instruction control unit, configured to execute the unlock instruction.

In still another embodiment of the present disclosure, the validity period of the control permission is once.

### Second Embodiment of Device

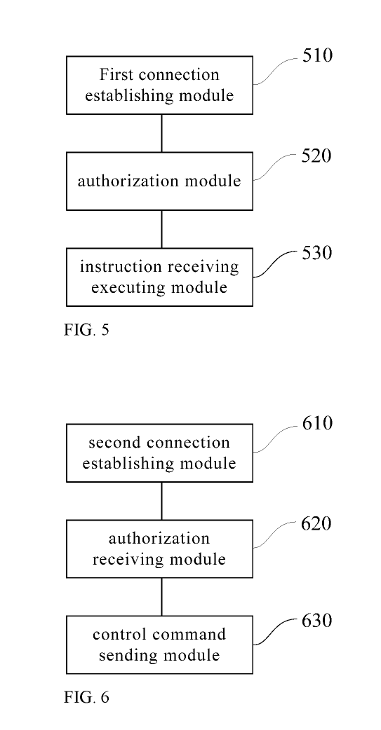

Referring to FIG. 6, it is a block diagram showing the structure of the remote control device in the second embodiment of the present disclosure, the embodiment may be adapted to the second apparatus, and may include:

a second connection establishing module 610, configured to establish Beidou short message connection with the first apparatus;

an authorization receiving module 620, configured to receive the control permission authorized by the first apparatus via the Beidou short message connection; and

a control command sending module 630, configured to send control command in accordance with the control permission to the first apparatus via the Beidou short message connection.

In a preferred embodiment of the present disclosure, the second connection establishing module 610 may include:

a second receiving sub-module, configured to receive the first Beidou short message from the first apparatus, the first Beidou short message carries a message for help;

a second sending sub-module, configured to send a second Beidou short message to the first apparatus, wherein the second Beidou short message carries the authority request message corresponding to the message for help;

a second connection establishing sub-module, configured to establishing a Beidou short message connection with the first apparatus according to the responding message from the first apparatus specific to the authority request message.

Each member embodiment of the present disclosure can be realized by hardware, or realized by software modules running on one or more processors, or realized by the combination thereof. A person skilled in the art should understand that a microprocessor or a digital signal processor (DSP) may be used in practical use to realize some or all the functions of some or all the members of the apparatus for recognizing advertisement plug-ins according to the embodiments of the present disclosure. The present disclosure may be further realized as some or all the equipments or device programs for executing the methods described herein (for example, computer programs and computer program products). This program for realizing the present disclosure may be stored in computer readable medium, or have one or more signal forms. These signals may be downloaded from the Internet website, or be provided by carrying signals, or be provided in any other manners.

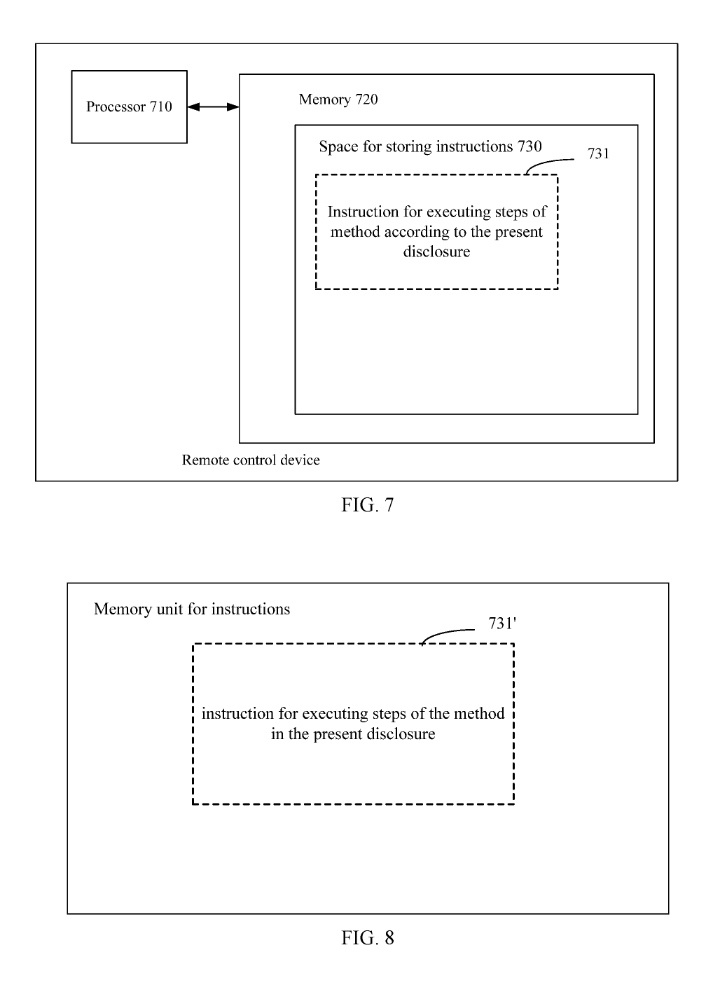

For example, FIG. 7 is a block diagram schematically showing a remote control device of the present disclosure. The remote control device includes a processor 710 and a computer program product or computer readable medium in the form of memory 720. The memory 720 may be an electronic memory such as a flash memory, EEPRPOM (electrically erasable programmable read-only memory), EPROM (electrically programmable read-only memory), hard disk or ROM (read-only memory). The memory 720 has a memory space 730 for storing instructions for executing any of the steps in the above method. For example, the memory space 730 for storing the instructions may include each instruction 731 for realizing steps in the above methods respectively. The instruction may be read out from one or more computer program product or write in one or more computer program product. The computer program product includes instruction carrier such as hard disk, compact disk (CD), storage card, or soft disk. The computer program product is usually a portable or non-portable memory unit shown in FIG. 8. The memory unit may have similar-arranged memory paragraph, memory space and the like as the memory 720 of the remote control device in FIG. 7. The instructions may be, for example, compacted in appropriate form. Generally, the memory unit includes a computer readable code 731′, that is, the code which may be read by processor such as the processor 710. When the instruction is executed by the remote control device, the remote control device is made to execute the steps in the methods above.

The device embodiment is described above merely for a schematic purpose, wherein the units explained as individual members may or may not be physically separated, the members shown as units may or may not be physical units and they can be located in a place or also can be distributed to network units. As necessary in practice, some or all of the modules can be selected to complete the objectives of the schemes of the embodiments. An ordinary person skilled in the art may understand and implement the embodiments without contributing creative labor.

Through above description of the implementations, it is obvious for the skilled in the art that the implementations can be completed by means of software in connection with necessary universal hardware platform or of course by means of hardware. Based on this understanding, the essence of aforesaid technical schemes or the part contributing to the prior art can be embodied in a form of software product. The computer software product can be stored in computer readable storage medium, such as ROM/RAM, magnetic disc, compact disc and the like, which contains a plurality of instructions such that a computing device (such as, personal computer, server or network apparatus) is able to execute the methods as described in the embodiments or a portion of the embodiment.

In the end, it should be explained that aforesaid embodiments are provided for the illustrative not limiting purpose of the technical schemes of the present disclosure. Although the present disclosure has been described in detail with reference to the embodiments, it should be understood that modifications or equivalent substitutions can be made to the technical schemes or some of technical features therein as disclosed in the embodiments by those skilled in the art; the modifications or substitutions will not bring the essence of the respective technical schemes to depart from spirit and scope of the technical schemes of the inventive embodiments.

1. A remote control method, adapted to a first apparatus, comprising:
establishing Beidou short message connection with a second apparatus;
authorizing control permission to the second apparatus via the Beidou short message connection; and
receiving and executing a control command in accordance with the control permission from the second apparatus via the Beidou short message connection.

2. The method according to claim 1, wherein the step of establishing Beidou short message connection with the second apparatus comprises:
sending a first Beidou short message to the second apparatus, the first Beidou short message carrying a message for help;
receiving a second Beidou short message from the second apparatus, the second Beidou short message carrying an authority request message corresponding to the message for help;
establishing the Beidou short message connection with the second apparatus according to the authority request message in the second Beidou short message.

3. The method according to claim 2, wherein the step of establishing Beidou short message connection with the second apparatus according to the authority request message in the second Beidou short message comprises:
verifying the authority request message and the message for help;
establishing the Beidou short message connection with the second apparatus when the authority request message and the message for help are in accordance with each other.

4. The method according to claim 1, wherein the control permission comprises an unlock permission, the control command in accordance with the control permission comprises an unlock instruction;
the step of receiving and executing the control command in accordance with the control permission from the second apparatus comprises:
receiving the unlock instruction from the second apparatus;
sending the unlock instruction to an instruction control unit via a controller area network;
executing the unlock instruction via the instruction control unit.

5. The method according to claim 1, wherein the validity period of the control permission is once.

6. A remote control method, adapted to a second apparatus, comprising:
establishing a Beidou short message connection with a first apparatus;
receiving a control permission authorized by the first apparatus via the Beidou short message connection;
sending a control command in accordance with the control permission to the first apparatus via the Beidou short message connection.

7. The method according to claim 6, wherein the step of establishing the Beidou short message connection with the first apparatus comprises:
receiving a first Beidou short message from the first apparatus, the first Beidou short message carrying a message for help;
sending a second Beidou short message to the first apparatus, the second Beidou short message carrying an authority request message corresponding to the message for help;
establishing Beidou short message connection with the first apparatus according to a responding message from the first apparatus specific to the authority request message.

8. A remote control device adapted to a first apparatus, comprising:
at least a first processor;
a first memory for storing at least one instruction executable by the first processor;
wherein the first processor is configured to:
establish a Beidou short message connection with a second apparatus;
authorize a control permission to the second apparatus via the Beidou short message connection; and
receive and execute a control command in accordance with the control permission from the second apparatus via the Beidou short message connection.

9. The device according to claim 8, wherein the first processor is further configured to:
send a first Beidou short message to the second apparatus, the first Beidou short message carrying a message for help;
receive a second Beidou short message from the second apparatus; the second Beidou short message carrying an authority request message corresponding to the message for help;
establish the Beidou short message connection with the second apparatus according to the authority request message in the second Beidou short message.

10. The device according to claim 9, wherein the first processor is further configured to:
verify the authority request message and the message for help;
establish the Beidou short message connection with the second apparatus when the authority request message and the message for help are in accordance with each other.

11. The device according to claim 8, wherein the control permission comprises an unlock permission, the control command in accordance with the control permission comprises an unlock instruction;
the first processor is further configured to:
receive the unlock instruction from the second apparatus;
send the unlock instruction to an instruction control unit via a controller area network;
execute the unlock instruction.

12. The device according to claim 8, wherein the validity period of the control permission is once.

13. A remote control device, adapted to a second apparatus, comprising:
at least a second processor a second memory for storing at least one instruction executable by the second processor;
wherein the second processor is configured to:
establish Beidou short message connection with a first apparatus;
receive a control permission authorized by the first apparatus via the Beidou short message connection; and
send a control command in accordance with the control permission to the first apparatus via the Beidou short message connection.

14. The device according to claim 13, wherein the second processor is further configured to:
receive a first Beidou short message from the first apparatus, the first Beidou short message carrying a message for help;
send a second Beidou short message to the first apparatus; the second Beidou short message carrying an authority request message corresponding to the message for help;
establish the Beidou short message connection with the first apparatus according to a responding message from the first apparatus specific to the authority request message.
